(19) United States
(12) Patent Application Publication
(10) Pub. No.: US 2010/0269653 A1
(43) Pub. Date: Oct. 28, 2010

(54) HANDS-FREE PAPER TOWEL DISPENSER

(75) Inventor: Bjorn Larsson, Billdal (SE)

Correspondence Address: YOUNG & THOMPSON, 209 Madison Street, Suite 500, Alexandria, VA, 22314, US

(73) Assignee: SCA HYGIENE PRODUCTS AB, Goteborg (SE)

(21) Appl. No.: 12/809,635

(22) PCT Filed: Dec. 21, 2007
(86) PCT No.: PCT/SE07/01169

§ 371 Date: Jun. 21, 2010

(51) Int. Cl. B26D 5/00

(52) U.S. Cl. 83/72

(57) ABSTRACT

A hands-free paper towel dispenser arranged to dispense towels in response to a first sensor (14) sensing the presence of a user and activating a drive unit (10), which automatically initiates the dispensing of the web of towels out of the dispenser into a first position (A), allowing a predetermined length of web to be cut by a cutting element (11) and removed by the user. The operation is completed by activating the feeding mechanism and positioning a leading edge of the web of towels in a second position (B) inside a dispensing opening (7), in which second position at least a portion of the leading edge of the web of towels is visible to the user adjacent the lower edge (8) of the dispenser unit.

### TECHNICAL FIELD

The invention relates to a hands-free paper towel dispenser comprising a housing for holding a continuous web of towels, which housing has an outer front wall and two outer side walls. The outer front wall comprises a dispensing opening for the web of towels at its lower edge. The dispenser further comprises a feeding mechanism for controlling the dispensing of the web of towels, a drive unit and a cutting means for the web and at least one sensor for sensing a user and activating a feeding mechanism and for monitoring the dispensing of a towel.

### BACKGROUND ART

Automatic touch free dispensers or hands-free dispensers for paper towels of tissue paper or non-woven are known on the market. The hands-free dispensers are electronically manoeuvred, they store and advance the paper towel with different kinds of control devices, sensors and power sources available on the market, and they are usually battery driven. Without touching the dispenser, i.e. hands-free, the user can get a paper towel that is fed automatically by the electronic dispenser. Dispensers like this are commonly used in public lavatories for dispensing paper towels to users. The most common type of a powered, hands-free dispenser is a roll dispenser with different kind of sensors used to initiate the mechanisms for advancing the towel such that the next sheet is presented to the user. Some examples of different electronic hands-free roll towel dispensers are disclosed in U.S. Pat. No. 4,666,099, U.S. Pat. No. 4,796,825, U.S. Pat. No. 4,826,262, U.S. Pat. No. 5,452,832, U.S. Pat. No. 5,772,291, U.S. Pat. No. 6,412,655, WO 99/59457 and WO 00/63100. There is a wide range of various sensors used in the dispensers, such as IR sensors, radio frequency disruption sensors, capacity sensors, motion or light detectors, mechanical detectors, photoelectric cell or proximity detectors.

One problem with dispensers of this type is that it may not be obvious to the user where the hands should be positioned to trigger a sensor and initiate a feeding operation. In cases where the sensor or a symbol indicating a sensor operated dispenser is located on the front of the dispenser, the user may attempt to press the dispenser in this location. This can cause soiling of the sensor and/or the dispenser, as well as breakage of the sensor if it is subjected to repeated excessive pressure.

In order to solve this problem it may be necessary to allow a leading edge of the towel to extend out of the dispenser. Firstly, this is not desirable from a hygienic point of view. Secondly, a user may be able to grab and pull the leading edge of the towel before the mechanism has started to feed the web. If the web is subjected to a pulling force prior to or during the feeding operation, then the operation may be disrupted by the web tearing in the wrong position or wedging a feeding mechanism, causing the dispenser to malfunction.

### DISCLOSURE OF INVENTION

The invention aims to solve the above problems by providing an improved hands-free dispenser as defined by the appended claims.

According to one embodiment of the invention, these objects are achieved by means of a hands-free paper towel dispenser comprising a housing for holding a continuous web roll of towels of tissue paper or non-woven. Alternatively, the housing may hold a pile of a continuous length of accordion-like folded web of towels of tissue paper or non-woven comprising bundles of a continuous length of accordion-like folded web of towels of tissue paper or non-woven. The housing comprises an outer front wall, two outer side walls and said outer front wall comprising a dispensing opening for the web of towels at its lower edge. The dispenser further comprises a feeding mechanism for controlling the dispensing of the web of towels, a drive unit, a cutting means and a braking arrangement for the web of towels and at least one sensor for controlling the dispensing of a towel. The feeding mechanism may comprise a drive unit and a braking arrangement for controlling the dispensing of the web of towels from the outer periphery of the roll or the upper part of the pile. The braking arrangement may be a separate unit or be integrated in the drive unit. The feeding mechanism is arranged to position a leading edge of the web of towels in a starting mode in the dispensing opening. During dispensing the paper towel is fed forward to assume a substantially flat form when it is dispensed through the dispensing opening. The dispenser also comprises a microprocessor for controlling the dispensing of the web of towels. The microprocessor for controlling the dispensing of the web of towels may also comprise a sensor, such as a level sensor, that detects the last towels of the web of towels. The drive unit preferably comprises a motor and a pair of driving or feeding rollers. When the dispenser is not driven by electricity from the mains, the drive unit may also comprise a battery unit.

The dispenser comprises a first sensor means in the form of a starting sensor, which senses the presence of a user, and activates the drive unit in the feeding mechanism. The feeding mechanism will then automatically initiate the dispensing of the web of towels to a hands-free position. An automatic dispenser including a suitable sensor means, in the form of an active IR sensor system, for detecting a user is known from WO 2007/006329, which is hereby incorporated by reference. According to this document, the IR system includes emitters and receivers which are mounted so that each IR emitter's active emitting portion protrudes outwardly from an outer surface of the housing and each IR receiver's active receiving portion is recessed behind that outer surface, such that the outward protrusion of the active receiving portion from the outer surface of the housing is less than the outward protrusion of the active emitting portion. The outer surface of the housing in question is preferably located at the bottom of the housing next to the discharge outlet. This arrangement allows a reliable and accurate IR reception field to be obtained with a shape more suited to the expected user positioning. Sensor arrangements as described in this document are suitable for use in a dispenser according to the invention. The starting sensor, hereinafter referred to as the “first sensor means”, may comprise one or more transmitting and receiving units adjacent the dispenser opening and the sensor preferably has an operating range of approximately 30 cm from its location. The first sensor means is usually located in close proximity to the dispensing opening, for instance at the lower edge of the outer front wall. When the hand of a user approaches the first sensor means near the dispensing opening, the web of towels will thus automatically be presented in the hands-free position and thereby ready to use. The length of the web of towels presented in the hands-free position is preferably from about 15 to about 50 cm. This length may be set by programming the microprocessor.

The first sensor means is arranged to sense the presence of a user and to activate the feeding mechanism, which in turn will automatically initiate the dispensing of a leading edge of the web of towels to a first position, wherein a predetermined length of web is arranged to be cut by the cutting means and removed by the user. The length can be set by programming the microprocessor, for instance by adjusting a period of time during which the drive unit is to be operated, or by a sensor determining a set number of rotations of the driven roller The user can grab the dispensed web of towels and easily detach a towel from the continuous web of towels by tearing it off directly from the web by using a tear bar or a tearing edge. Subsequently, the feeding mechanism is arranged to position the leading edge of the web of towels in a second position inside the dispensing opening, in which second position at least a portion of the leading edge of the web of towels is visible to the user adjacent the lower edge of the dispenser unit. This position is determined by a second sensor means, in the form of a position sensor in the dispensing opening. The second sensor means is arranged to transmit a signal to the microprocessor to start the driven roller to feed the web when no web is detected in front of the second sensor means, and to stop the driven roller when the leading edge reaches the second position. The feeding mechanism is arranged to position the leading edge of the web of towels in the second position subsequent to the removal of a length of web. When in the second position, the leading edge of the web of towels is located above a lowermost edge of the outer front wall. Preferably, the leading edge of the web of towels is located within the outer walls of the housing when the leading edge of the web is located in the second position. According to the invention, the web of towels is kept in the dispensing opening by the braking arrangement when in the starting mode. The starting mode is identical to the second position taken up by the web after a user has taken a towel and a subsequent towel has been fed to a dispensing position, but before a new towel is automatically fed out. The term starting mode means that the leading edge of the web of towels is positioned close to the dispensing opening but that the entire towel, or at least the main part of the towel, is still protected by the dispenser, mostly for hygienic reasons. The web of towels is thereby protected as far as possible before it is being used. When in the second position, the leading edge of the web of towels is visible but not accessible in a cut-out section in or adjacent the lowermost edge of the outer front wall or, alternatively, visible through a transparent section located in or adjacent the lower edge of the outer front wall. This arrangement will intuitively lead the user to move a hand towards the visible leading edge of the towel, which will automatically put the hand within the range of at least one proximity sensor and activate the dispenser.

The function of the sensors and/or detectors used may be of an optical type, preferably of the infra red (IR) type, but alternative types of sensors may also be used. Examples of suitable sensor types are capacitive, radio frequency, motion, proximity or light sensors or detectors, photoelectric cells etc. The sensors may be operated using electric power from the mains or an internal source of energy within the dispenser, such as batteries.

In operation the hands-free paper towel dispenser is arranged to dispense towels by sensing the presence of a user and activating a feeding mechanism, which automatically initiates the dispensing of the web of towels out of the dispenser into a first position, allowing a predetermined length of web to be cut by a cutting means and removed by the user. The operation is completed by activating the feeding mechanism and positioning a leading edge of the web of towels in a second position inside a dispensing opening, in which second position at least a portion of the leading edge of the web of towels is visible but not accessible to the user adjacent the lower edge of the dispenser unit.

The operation involves feeding the leading edge of the web of towels into the second position subsequent to the removal of the cut length of web, which second position is located above a lowermost edge of the outer front wall or within the outer periphery of the outer walls of the housing.

When feeding the leading edge of the web of towels into the second position, said leading edge may be located in a cut-out section of the lowermost edge of the outer front wall, wherein the leading edge of the web of towels is visible but not accessible to the user. Alternatively, the leading edge may be located behind a transparent section adjacent the lower edge of the outer front wall, through which the leading edge of the web of towels is visible.

### BRIEF DESCRIPTION OF DRAWINGS

The invention will be described in detail with reference to the attached figures. It is to be understood that the drawings are designed solely for the purpose of illustration and are not intended as a definition of the limits of the invention, for which reference should be made to the appended claims. It should be further understood that the drawings are not necessarily drawn to scale and that, unless otherwise indicated, they are merely intended to schematically illustrate the structures and procedures described herein.

FIG. 1 shows a schematic perspective view of a dispenser according to the invention,

FIG. 2 shows a schematic cross-sectional view of the dispenser in FIG. 1.

### EMBODIMENTS OF THE INVENTION

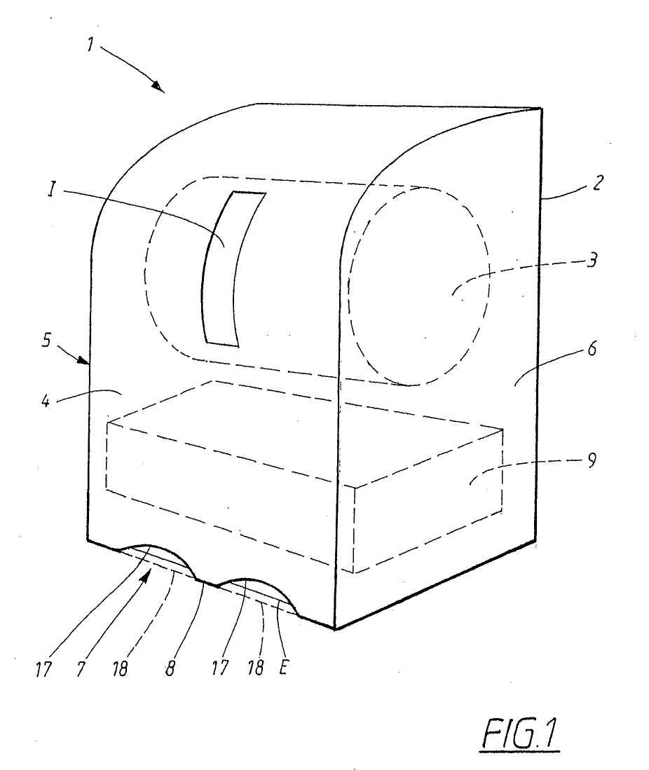

FIG. 1 shows a schematic perspective view of a hands-free paper towel dispenser according to the invention. The figure shows a dispenser 1 comprising a housing 2 for holding a roll 3 comprising a continuous web of towels, said housing 2 comprising an outer front wall 4; two outer side walls 5, 6, as well as a top and a bottom wall extending rearwards from the respective upper and lower ends of the outer front wall 4. The outer front wall 4 comprises a dispensing opening 7 for the web of towels adjacent its lower edge 8. In FIG. 1 the housing 2 is drawn partially transparent in order to show the internal structure of the dispenser 1, including a schematically indicated feeding mechanism 9. In this particular embodiment, the housing is completely or partially opaque with a transparent indicator window I for allowing inspection of the filling level of the roll 3.

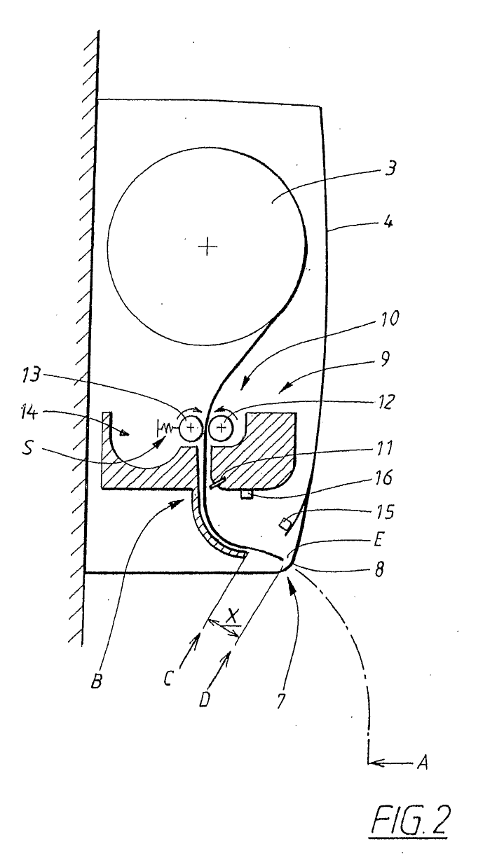

FIG. 2 shows a schematic cross-sectional view of the dispenser in FIG. 1. The dispenser 1 is provided with a feeding mechanism 9 for controlling the dispensing of the web of towels from the roll 3. The feeding mechanism comprises a drive unit 10 and a cutting means in the form of a tear bar 11 for the web of towels. In this example, the drive unit 10 comprises a first and a second roller 12, 13, where the first roller 12 is a driven roller and the second roller 13 is a spring loaded follower holding the web in contact with the first roller 12. This is schematically indicated by a spring means S. In the embodiment, the first and second rollers 12, 13 are also arranged to act as an integrated braking arrangement for the web. The function of the braking mechanism is to prevent the web from being unintentionally pulled out of the dispenser. Behind the rollers 12, 13 the feeding mechanism 9 is provided with a compartment 14 for a stub roll, whereby a nearly exhausted roll 3 is placed in said compartment 14 during a re-filling operation. The feeding mechanism 9 also comprises a microprocessor (not shown) for processing signals transmitted from various sensor means and for actuating the dispensing function. If the dispenser is of the battery operated type, the battery compartment can be located in or adjacent the feeding mechanism 9.

The dispenser further comprises a first sensor means 15 comprising a number of sensors (only one shown) adjacent the lower edge (8) of the front wall 4 for controlling the dispensing of a towel. In the current example, the first sensor means 15 for controlling the dispensing of the web of towels comprise a number of infrared sensor units located at the lower edge 8 of the outer front wall 4. According to one example, the first sensor means 15 comprises two IR-transmitters and three IR-receivers, wherein the IR-receivers are spaced apart by the two IR-transmitters. The sensor units are aimed outwards and downwards from the lower edge 8 of the dispenser. The first sensor means 15 has an operating range of not more than approximately 30 cm, extending in a tongue shape away from the front of the dispenser.

Alternative suitable sensor types include capacitive, motion, proximity or light sensors or detectors.

The first sensor means 15 is arranged to sense the presence of a user adjacent the dispenser and transmit a signal to the microprocessor to activate the feeding mechanism 9. The microprocessor will automatically initiate the drive unit 10 to dispense a leading edge E of the web of towels a predetermined length to a first position A. In this position the predetermined length of web is arranged to be pulled outwards and cut by the cutting means 11, in order to be removed by the user. In this case, the web is cut by the pulling action applied to the web by the user, which action causes the web to be forced into contact with a serrated cutting edge on the tear bar 11 in a position B. In this example the cutting means is a straight tear bar extending at least across the entire width of the web. The predetermined length of the web of towels presented to the user in the first position can be selected from 15 to 50 cm.

The length can be set by programming the microprocessor, for instance by adjusting the time the drive unit 10 is to be operated. The speed of rotation of the cooperating rollers 12, 13 is known and is programmed into the microprocessor. Once the web has been cut and removed by the user, an additional, second sensor means 16 detects that the web is no longer present in the dispensing opening 7. The second sensor means 16 is preferably a suitable position sensor that can detect the presence or absence of the web in front of the sensor, including the leading edge of the web as it is fed forward past the sensor means.

According to one example, the microprocessor will actuate the driven rollers 12, 13 and start a timer to dispense a subsequent length of web towards the presentation position D. When the rollers 12, 13 have been operated for a time corresponding to the distance from position B to a presentation position D, the rollers 12, 13 are stopped and the dispenser is ready for dispensing the next predetermined length of the web.

According to a second example the microprocessor will actuate the driven rollers 12, 13 to dispense a subsequent length of web towards the presentation position D. The second sensor means 16 is used for determining when the leading edge of the web passes an intermediate position C, which in this example represents the end of the guide directing the web towards the dispensing opening 7. When the leading edge E passes the intermediate position C the timer is started to allow the microprocessor to stop the rollers 12, 13 after a distance X, when the leading edge E has reached the presentation position D. The dispenser is then ready for dispensing the next predetermined length of the web. This example allows for greater reliability and accuracy, as the leading edge E must pass the second sensor means 16 before the dispensed distance is measured by the timer. This ensures that the subsequent length of web is actually fed forward. If the leading edge has not passed the second sensor means after a predetermined period of time, then this is an indication that the web is finished or that a malfunction has occurred. An error message can be generated for the attention of the servicing staff. Also, as the timer operates over a shorter time and a corresponding relatively short distance X, the accuracy of the feeding operation can be improved.

Alternatively, a sensor (not shown) on one of the driving rollers 12, 13 can be used for determining a set number of rotations of the driven roller 12, 13 corresponding to the distance between position B and position D. The same sensor can be used for determining the predetermined length to be dispensed from the presentation position D to position A where the user can tear of the length of web.

In all the above examples, the feeding mechanism is arranged to feed forward and position the cut leading edge E of the web of towels in the presentation position D inside the dispensing opening 7. In this position D at least a portion of the leading edge E of the web of towels is visible to the user adjacent the lower edge of the dispenser unit. In the example shown in FIG. 1, the leading edge E of the web of towels is visible in a pair of cut-out sections 17 of the lowermost edge of the outer front wall 4. Alternatively, the leading edge of the web can be visible through a transparent section 18 adjacent the lower edge of the outer front wall 4, as indicated by dashed lines in FIG. 1.

The feeding mechanism is arranged to position the leading edge of the web of towels in the presentation position D subsequent to the removal of a length of web. This prevents the web from being fed forward unnecessarily and avoids misuse of the dispenser. When in the presentation position D the leading edge E of the web of towels is located adjacent or above the lowermost edge 8 of the outer front wall 4. Alternatively the leading edge E can be located within the confines of the outer walls of the housing 2. In the presentation position D, the leading edge E of the web of towels is visible in at least one cut-out section of the lowermost edge of the outer front wall 4.

In operation the hands-free paper towel dispenser is arranged to dispense towels in response to a first sensor means sensing the presence of a user and activating a feeding mechanism, which automatically initiates the dispensing of the web of towels out of the dispenser into a first position A, allowing a predetermined length of web to be cut by a cutting means 11 when removed by the user. The operation is completed by a second sensor means 16 detecting that the length of web has been removed and activating the drive unit 10. The second sensor means 16 is then used for detecting the leading edge E of the web of towels in an intermediate position C inside the dispensing opening 7. After a predetermined time after passing the second position C the leading edge E of the web is stopped at a second position D, also referred to as the presentation position D, where at least a portion of the leading edge E of the web of towels is visible to the user adjacent the lower edge 8 of the dispenser unit.

The operation involves feeding the leading edge of the web of towels into the second position D subsequent to the removal of the cut length of web, which second position D is located above a lowermost edge 8 of the outer front wall or within the outer periphery of the outer walls of the housing.

When feeding the leading edge E of the web of towels into the second position D, said leading edge may be located in a cut-out section 17 of the lowermost edge 8 of the outer front wall, wherein the leading edge E of the web of towels is visible to the user. Alternatively, the leading edge may be located behind a transparent section 18 adjacent the lower edge 8 of the outer front wall 4, through which the leading edge E of the web of towels is visible.

The invention is not limited to the above examples, but may be varied freely within the scope of the appended claims.

1-19. (canceled)

20. A hands-free paper towel dispenser comprising a housing for holding a continuous web of towels, said housing comprising an outer front wall; two outer side walls, said outer front wall comprising a dispensing opening for the web of towels adjacent its lower edge, the dispenser further comprising a drive unit, a cutting means for the web of towels, at least one sensor means for controlling the dispensing of a towel, and a microprocessor for controlling the drive unit in response to signals from said at least one sensor means, wherein a first sensor means is arranged to sense the presence of a user and to activate the drive unit arranged to dispense a predetermined length of web in order to displace a leading edge of the web of towels to a first position, in which the predetermined length of web is arranged to be cut by the cutting means when removed by the user; and the drive unit is arranged to position the leading edge of the web of towels in a second position inside the dispensing opening, in which second position at least a portion of the leading edge of the web of towels is visible to the user adjacent the lower edge of the dispenser.

21. The hands-free paper towel dispenser according to claim 20, wherein the drive unit is arranged to position the leading edge of the web of towels in the second position subsequent to the removal of a length of web.

22. The hands-free paper towel dispenser according to claim 20, wherein when in the second position, the leading edge of the web of towels is located above a lowermost edge of the outer front wall.

23. The hands-free paper towel dispenser according to claim 20, wherein when in the second position, the leading edge of the web of towels is located within the outer walls of the housing.

24. The hands-free paper towel dispenser according to claim 20, wherein when in the second position, the leading edge of the web of towels is visible in a cut-out section of the lowermost edge of the outer front wall.

25. The hands-free paper towel dispenser according to claim 20, wherein when in the second position, the leading edge of the web of towels is visible through a transparent section adjacent the lower edge of the outer front wall.

26. The hands-free paper towel dispenser according to claim 20, wherein a second sensor means is located in the dispensing opening, said sensor means being arranged to transmit a signal to the microprocessor to start the drive unit to feed the web when no web is detected in front of the second sensor means, and to stop the drive unit when the leading edge reaches the second position.

27. The hands-free paper towel dispenser according to claim 20, wherein the first sensor means for controlling the dispensing of the web of towels comprises at least one sensor unit located at the lower edge of the outer front wall.

28. The hands-free paper towel dispenser according to claim 27, wherein the first sensor means comprises at least one infrared, capacitive, motion, proximity or light sensor or detector.

29. The hands-free paper towel dispenser according to claim 20, wherein the first sensor means has an operating range of not more than approximately 30 cm.

30. The hands-free paper towel dispenser according to claim 20, wherein the predetermined length of the web of towels presented to the user in the first position is from 15 to 50 cm.

31. The hands-free paper towel dispenser according to claim 20, wherein the lower edge of the dispenser unit is provided with at least one cut-out section or transparent section.

32. The hands-free paper towel dispenser according to claim 20, wherein the cutting means is a tear bar.

33. Method of dispensing paper towel from a hands-free paper towel dispenser according to claim 20, which comprises:
sensing the presence of a user and activating a drive unit, which automatically initiates the dispensing of the web of towels out of the dispenser into a first position,
allowing a predetermined length of web to be cut by a cutting means when removed by the user,
activating the drive unit and positioning a leading edge of the web of towels in a second position inside a dispensing opening, in which second position at least a portion of the leading edge of the web of towels is visible to the user adjacent the lower edge of the dispenser unit.

34. Method according to claim 33, further comprising feeding the leading edge of the web of towels into the second position subsequent to the removal of the cut length of web.

35. The method according to claim 33, further comprising feeding the leading edge of the web of towels into a second position located above a lowermost edge of the outer front wall.

36. The method according to claim 33, further comprising feeding the leading edge of the web of towels into a second position located within the outer walls of the housing.

37. The method according to claim 33, further comprising feeding the leading edge of the web of towels into a second position located in a cut-out section of the lowermost edge of the outer front wall, wherein the leading edge of the web of towels is visible.

38. The method according to claim 33, further comprising feeding the leading edge of the web of towels into a second position located behind a transparent section adjacent the lower edge of the outer front wall, through which the leading edge of the web of towels is visible.
